(19) United States
(12) Patent Application Publication
(10) Pub. No.: US 2005/0254888 A1
(43) Pub. Date: Nov. 17, 2005

(54) Torque rod and method of producing the same

(75) Inventor: Akira Oji, Inuyama-shi (JP)

Correspondence Address: OLIFF & BERRIDGE, PLC, P.O. BOX 19928, ALEXANDRIA, VA, 22320, US

(73) Assignee: TOKAI RUBBER INDUSTRIES, LTD., Komaki-shi (JP)

(21) Appl. No.: 11/113,096

(22) Filed: Apr. 25, 2005

(30) Foreign Application Priority Data
Apr. 28, 2004 (JP) 2004-132532

(51) Int. Cl. F16B 7/08

(52) U.S. Cl. 403/187

(57) ABSTRACT

A torque rod having: a rigid torque rod body of a form in which first and second outer cylinders at both ends are linked to each other by a linking portion; and a first and a second bushing each having a rigid inner cylinder and a rubber elastic body affixed thereabout, the first and second bushings being respectively installed within first and second outer cylinders. The second outer cylinder has an inside peripheral wall of inwardly protruding shape that becomes smaller in diameter moving towards the center from the axial ends. The rubber elastic body of the second bushing is a solid member having a shape corresponding to the inwardly protruding shape, with the second bushing installed directly press-fit in the axial direction into the second outer cylinder, at an outer circumferential face of the rubber elastic body.

### INCORPORATED BY REFERENCE

The disclosure of Japanese Patent Application No. 2004-132532 filed on Apr. 28, 2004 including the specification, drawings and abstract is incorporated herein by reference in its entirety.

### BACKGROUND OF THE INVENTION

1. Field of the Invention

The present invention relates to a torque rod that is interposed between the engine and body of a vehicle to control displacement of the engine in the engine rolling direction and the vehicle front-back direction, as well as to damp vibration between the engine and body.

2. Description of the Related Art

Conventionally, torque rods are mounted between the engine and body of a vehicle. These torque rods have first and second bushings at both ends, each of which has an outer and inner cylinder, with a rubber elastic body interposed therebetween, and a linking portion for connecting the first and second bushings, so that the torque rods can take up the torque from the engine to control displacement in the engine rolling direction and the front-back direction. Such torque rods also damp vibration between the engine and body.

Conventionally used torque rods include the parallel type of torque rod in which the first and second bushings are disposed in the same direction, and the perpendicular type of torque rod in which the first and second bushings are disposed facing each other at right angles.

For instance, torque rods of the former parallel type have been disclosed, for example, in JP-U-50-3217, JP-B-4-74569, JP-B-5-14806, JP-A-6-109075 and JP-A-7-197927, and the latter perpendicular type has been disclosed in JP-A-8-233030 and JP-A-2003-206991.

FIG. 4 illustrates an example of such torque rod. In the drawing, 200 is a torque rod, and 202 is a torque rod body of metal (e.g., an aluminum alloy). The torque rod body 202 includes at its first end a large-diameter first outer cylinder 204, and at its other end a small diameter outer cylinder 206, which are disposed facing each other at right angles. The first and second outer cylinders 202, 204 are mutually connected together by means of a linking portion 208.

210 is a first bushing comprising a large bushing assembled within the first cylinder 204. This first bushing 210 comprises a rigid inner cylinder 212 of metal, a rubber elastic body adhered to an outside face of the inner cylinder 212, and a metal sleeve 216 adhered to an outside face of the rubber elastic body 214. The first bushing 210 is secured press fit at an outside face of the metal sleeve 216 into the first outer cylinder 204 in the axial direction, thereby being assembled within the first outer cylinder 204. A pair of hollow portions 218, 220 are formed through the rubber elastic body 214 of the first bushing 210 in the axial direction, at respective positions opposed to each other in the vehicle front-back direction, i.e., the axial direction of the linking portion 208.

Within the second outer cylinder 208 on the other end of the torque rod body 202, there is assembled a second bushing 222 comprising a small bushing. The second bushing 222, likewise, comprises -a rigid inner cylinder 224 of metal, a rubber elastic body 226 adhered to an outside face of the inner cylinder 224, and a metal sleeve 228 adhered to an outside face of the rubber elastic body 226. This second bushing 222 is secured press fit at an outside face of the metal sleeve 228 to the second outer cylinder 206 in the axial direction, thereby assembled within the second outer cylinder 206.

In both the first and second bushings 210, 222, the rubber elastic bodies 214, 226 are integrally bonded by vulcanization to the inner metal cylinder 212, 224 and the metal sleeves 216, 228, respectively.

In the second bushing 222, an axial intermediate part between the both axial ends thereof, i.e. the part embedded within the rubber elastic body 226 and opposite in the substantially axis-perpendicular direction to the metal sleeve 228, has an diametrically outward protruding shape. In the drawing, 230 denotes a protruding portion. It should be appreciated that the protruding portion 230 is formed on the inner cylinder 224 on the second bushing 222 side, so that a wall thickness of the rubber elastic body 226 is made thin in the diametric direction by the presence of the protruding portion 230. This arrangement can increase the spring constant (spring stiffness) of the second bushing 222 as measured in the axis-perpendicular direction, thereby preventing resonance of the torque rod 200 upon acceleration of a vehicle, and restricting occurrence of noises.

However, in the event of the torque rod 200, a need for the metal sleeve 228 in the second bushing 222 requires an additional cost for the component, and the manufacturing process of the second bushing 222 requires an adhere treatment for executing an vulcanization bonding between the metal sleeve 228 and the rubber elastic body 226. Additionally, a drawing operation for decreasing a diameter should be also executed against the metal sleeve 228, after the rubber elastic body 226 and the metal sleeve 228 are integrally bonded through vulcanization. Consequently, a great number of steps are needed for manufacturing the torque rod 200, resulting in a problem of a high manufacturing cost. Further, in order to axially press fit the second bushing 222 into the second outer cylinder 206 at the metal sleeve 228, an inner circumferential face of the outer cylinder 206 should be subject to a cutting treatment in advance. In addition, a process for producing the protruding portion 230 on the inner cylinder 224 is required. These boost the manufacturing cost of the torque rods. Besides the need of the metal sleeve 228, the torque rod 200 suffer from a problem increase of the weight of the second bushing 222 due to the protruding portion 230 of the inner cylinder 224 that increases the wall thickness of the inner cylinder 224.

### SUMMARY OF THE INVENTION

It is an object of the present invention to provide a torque rod that maintains functionality comparable to the prior art but at lower cost, and that enables reduced weight.

It is an another object of the present invention to provide a method of producing the torque rod of the invention, as well.

The above and/or optional objects of this invention may be attained according to at least one of the following modes of the invention. Each of these modes of the invention is numbered like the appended claims and depending from the other mode or modes, where appropriate, to indicate possible combinations of elements or technical features of the invention. It is to be understood that the principle of the invention is not limited to these modes of the invention and combinations of the technical features, but may otherwise be recognized based on the teachings of the present invention disclosed in the entire specification and drawings or that may be recognized by those skilled in the art in the light of the present disclosure in its entirety.

A first mode of the invention provides a torque rod comprising: a rigid torque rod body of a form in which first and second outer cylinders at both ends are linked to each other by a linking portion; and a first and a second bushing each having a rigid inner cylinder and a rubber elastic body affixed thereabout, the first and second bushings being respectively installed within first and second outer cylinders, wherein the second outer cylinder has an inside peripheral wall of inwardly protruding shape that becomes smaller in diameter moving towards the center from the axial ends; and the rubber elastic body of the second bushing has a shape corresponding to the inwardly protruding shape, with the second bushing installed directly press-fit in the axial direction into the second outer cylinder, at an outer circumferential face of the rubber elastic body.

A second mode of the invention provides a torque rod according to the first mode, wherein the rubber elastic body of the second bushing has a diametrically inwardly annular recessed portion open in an outer circumferential face thereof at an axially intermediate portion, corresponding to the inwardly protruding shape of the second outer cylinder.

A third mode of the invention provides a torque rod according to the first or second mode, wherein the torque rod body is a molded component composed of molding material injected in a fluid state into a forming mold and hardened.

A fourth mode of the invention provides a torque rod according to any one of first through third modes, wherein the first bushing is a large bushing of larger diameter than the second bushing, and the second bushing is a small bushing.

A fifth mode of the invention provides a torque rod according to the fourth mode, wherein the rubber elastic body of the first bushing comprising the large bushing has hollow portions disposed at both sides of the inner cylinder in the axial direction of said linking portion, which coincides with a vehicle front-back direction.

A sixth mode of the invention provides a torque rod according to any one of claims the first through fifth modes, wherein the rubber elastic body of the second bushing in a state prior to being press-fit has a diametrically inwardly annular central recessed portion open in an outer circumferential face thereof at an axially intermediate portion, and a pair of diametrically inwardly annular side recessed portions open in the outer circumferential face thereof at both axial sides of the central recessed portion, with a depth length smaller than that of the central recessed portion, while a pair of flange portions 46 integrally formed at two axial ends thereof so as to project diametrically outward in annular configuration.

As set forth hereinabove, in the present invention, the second outer cylinder has an inside peripheral wall of inwardly protruding shape that becomes smaller in diameter moving towards the center from the axial ends, with the rubber elastic body of the second bushing having a shape that corresponds to the inwardly protruding shape, and with the second bushing installed directly press-fit in the axial direction into the second outer cylinder with inwardly protruding shape at the outer circumferential face of the rubber elastic body. That is, the present invention dispenses with the metal sleeve of the bushing required in the prior art, instead installing it with the rubber elastic body directly press-fit into the outer cylinder of the torque rod body.

According to the present invention, in addition to the fact per se that a metal sleeve is unnecessary, there is also no longer any need for a bonding process to bond the metal sleeve and the rubber elastic body together, a caulking process in order to constrict the diameter of the metal sleeve after vulcanization, or a cutting process performed on the inside circumferential face of the outer cylinder prior to press-fitting. Additionally, since there is no need to provide a protruding portion on the outside circumferential face of the inner cylinder so that the outside circumferential face of the inner cylinder can be a straight surface, the cost of producing the second bushing and of installation in the outer cylinder can be made lower, and thus the cost of the torque rod per se can be reduced. Since the metal sleeve can be dispensed with and the need to provide a protruding portion on the outside circumferential face of the inner cylinder is obviated so that its wall can be made thinner, the weight of the second bushing, and accordingly the weight of the torque rod, can be reduced so as to respond to the demand for lighter vehicle weight.

In the present invention, since the shape of the second outer cylinder of the torque rod body is an inwardly protruding shape that becomes smaller in diameter moving towards the center from the axial ends, even if the outer circumferential face of the inner cylinder of the corresponding bushing is of straight shape, the wall thickness of the rubber elastic body in the axis-perpendicular direction can be made as thin as in the prior art, so that the characteristics required of a torque rod can be preserved. Here, the shape of the rubber elastic body of the second bushing that corresponds to the second outer cylinder with the aforementioned inwardly protruding shape is a shape having on the outer circumferential face and axial center portion thereof a diametrically inward annular recessed portion corresponding to the aforementioned inwardly protruding shape (Second Mode).

According to the third mode, the torque rod body is constituted as a molded component, and more particularly as a molded component of molding material injected in a fluid state into a forming mold and hardened, so that the torque rod body can be constituted as a molded component in this way. Therefore, an inwardly protruding shape like that mentioned above can be produced easily without subjecting the outer cylinder corresponding to the second bushing to a cutting process. Additionally, by employing this kind of inwardly protruding shape, it is possible to impart the draft angle required for demolding to the outer cylinder forming section of the torque rod forming mold.

The present invention is especially effective when implemented on the small bushing end of a torque rod in which the aforementioned first bushing is a large bushing and the second bushing is a small bushing (Fourth Mode).

In the present invention, hollow portions (recesses) may be disposed at both sides of the inner cylinder in the axial direction of the linking portion, which coincides with the vehicle front-back direction (Fifth Mode).

According to the present invention, in order to eliminate a need for the metallic intermediate sleeve or other additional component, while achieving a required characteristics, i.e. an increased spring stiffness in the axis perpendicular direction, the present invention adopt a combination of the second outer cylinder of aforementioned unique configuration and the second bushing of aforementioned unique configuration. Namely, the second outer cylinder has the inside peripheral wall of inwardly protruding shape that becomes smaller in diameter moving towards the center from the axial ends. This unique configuration of the second outer cylinder makes is difficult to axially press-fit the second bushing into the bore of second outer cylinder, due to the presence of the central throttled portion. In order to make the press-fit process easy, if the second bushing is formed in the conventional round cylindrical configuration with a reduced wall thickness, a gap would be made at both axial end portions between the second outer cylinder and the rubber elastic body. To address this problem, if the second bushing is formed in the conventional round cylindrical configuration with a increased wall thickness, an axially central portion of the rubber elastic body is subjected to considerable stress, resulting in low durability of the second bushing.

To ensure a desired press-fitting of the second bushing to the second cylinder of unique configuration, the present rubber elastic body of the second bushing has the unique configuration as defined in the sixth mode. The presence of the central recessed portion makes it easy to insert the second bushing through the throttled portion of the second outer cylinder. The presence of the pair of side recessed portions makes it more easy to press fit the second bushing. Further, the side-recessed portion provides a large free surface of the rubber elastic body, enhancing durability of the second bushing. Additionally, the combination of the central recessed portion and the side-recessed portion makes it possible to closely fit the flange portions onto the end faces of the second outer cylinder, with high stability. Thus, the vibration-damping rod of construction according to the sixth mode of the invention ensures a further enhanced tightness between the second bushing and the second outer cylinder, preventing dislodging of the second bushing from the second outer cylinder.

A seventh mode of the invention provides a method of producing a torque rod including a rigid torque rod body of a form in which first and second outer cylinders at both ends are linked to each other by a linking portion; and a first and a second bushing each having a rigid inner cylinder and a rubber elastic body affixed thereabout, the first and second bushings being respectively installed within first and second outer cylinders, wherein the second outer cylinder has an inside peripheral wall of inwardly protruding shape that becomes smaller in diameter moving towards the center from the axial ends; and the rubber elastic body of the second bushing is a solid member having a shape corresponding to the inwardly protruding shape, with the second bushing installed directly press-fit in the axial direction into the second outer cylinder, at an outer circumferential face of the rubber elastic body, the method comprising the steps of: (a) preparing the second outer cylinder by die-casting so that the second outer cylinder has the inside peripheral wall of inwardly protruding shape; (b) preparing the second bushing by forming and bonding the rubber elastic body onto an outer circumferential face of the rigid inner cylinder by vulcanization such that the rubber elastic body in a state prior to being press-fit has a diametrically inwardly annular central recessed portion open in an outer circumferential face thereof at an axially intermediate portion, and a pair of diametrically inwardly annular side recessed portions open in the outer circumferential face thereof at both axial sides of the central recessed portion with a depth length smaller than that of the central recessed portion, while a pair of flange portions 46 integrally formed at two axial ends thereof so as to project diametrically outward in annular configuration; and (c) press fitting the prepared second bushing directly in the axial direction into the prepared second outer cylinder at the outer circumferential face thereof so that the rubber elastic body has a shape corresponding to the inwardly protruding shape by means of an elastic deformation thereof.

### BRIEF DESCRIPTION OF THE DRAWINGS

The forgoing and/or other objects features and advantages of the invention will become more apparent from the following description of a preferred embodiment with reference to the accompanying drawings in which like reference numerals designate like elements and wherein:

FIGS. 1A and 1B is a perspective view of a torque rod of construction according to a first embodiment of the invention;

FIG. 2A is a front view in part section of the torque rod of FIG. 1, and FIG. 2B is a vertical cross sectional view of the torque rod of FIG. 1;

FIGS. 3A and 3B are views illustrating steps of manufacturing the torque rod of FIG. 1;

FIGS. 4A and 4B are views illustrating an example of conventional torque rod;

FIGS. 5A and 5B is views illustrating a step of manufacturing the conventional torque rod of FIGS. 4A and 4B.

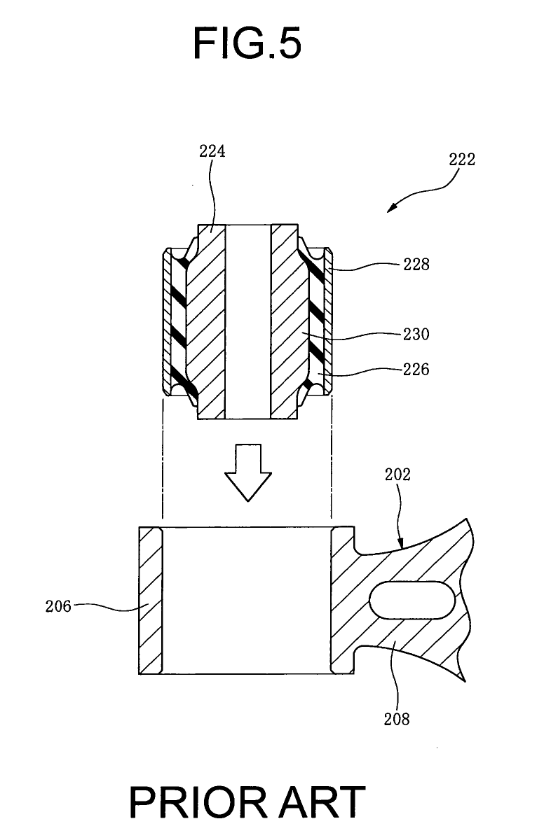

### DETAILED DESCRIPTION OF PREFERRED EMBODIMENTS

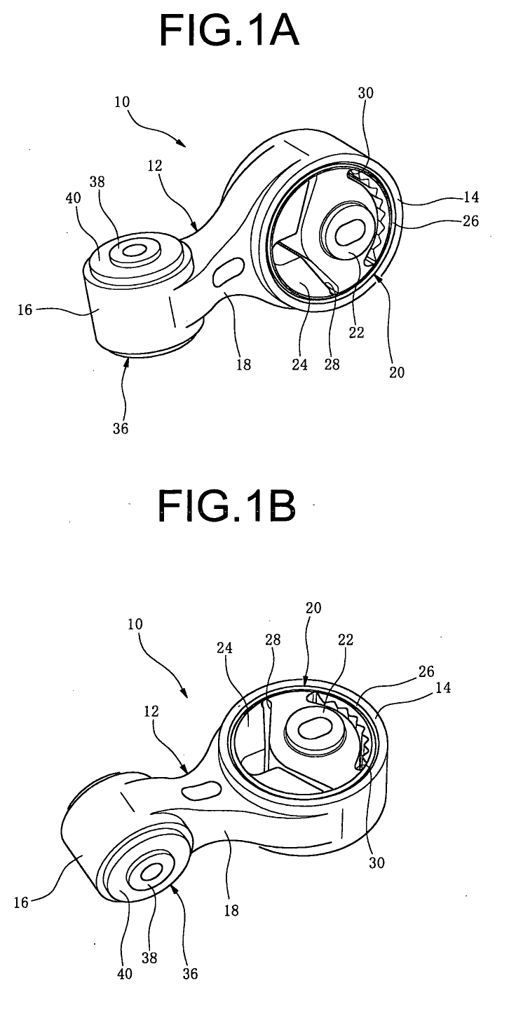

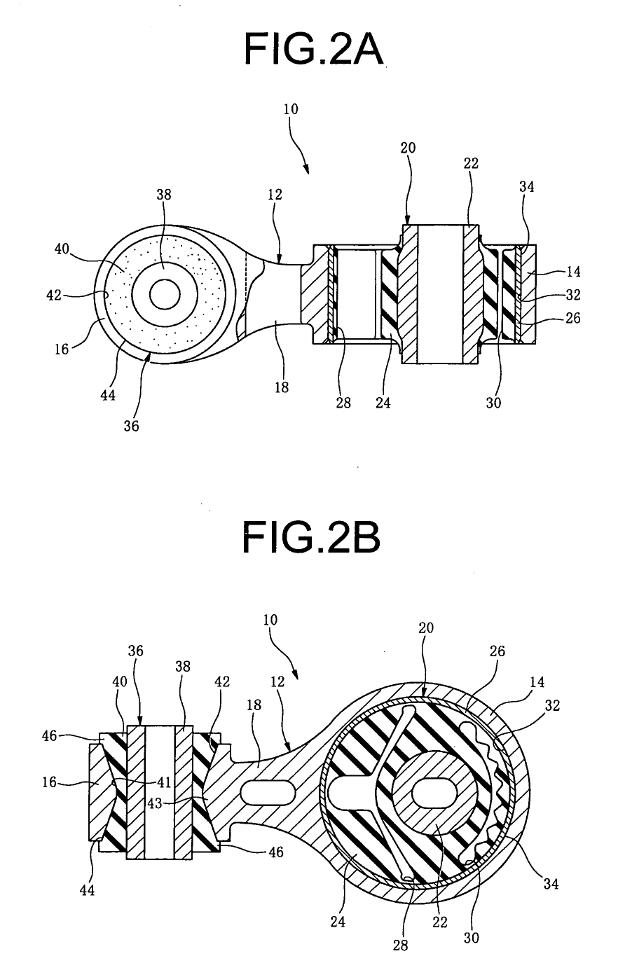

The embodiment of the invention is described in detail hereinbelow with reference to the drawings. In FIG. 1 and FIG. 2, 10 denotes a torque rod of construction according to the present embodiment, and 12 denotes a torque rod body fabricated of aluminum alloy (e.g., die-cast aluminum). The torque rod body 12 has at a first end thereof a first outer cylinder 14 of large-diameter round cylindrical shape, and at the other end thereof a small-diameter second outer cylinder 16 oriented in a direction forming a right angle therewith, with these being linked together by a linking portion 18.

20 denotes a first bushing consisting of a large bushing installed within the large-diameter first outer cylinder 14; it comprises a metal rigid inner cylinder 22, a rubber elastic body 24 attached thereabout, and a round cylindrical metal sleeve 26 attached to the outer circumferential face thereof. The rubber elastic body 24 is integrally bonded by vulcanization to the inner cylinder 22 and the metal sleeve 26. Hollow portions 28, 30 that pass through the bushing in the axial direction are disposed to either side of the inner cylinder 22 in the vehicle front-back or longitudinal direction, i.e. the axial direction of the linking portion 18.

As shown in FIG. 2A, the first outer cylinder 14 of round cylindrical shape has an inner circumferential face 32 that is of straight shape in the axial direction, while the metal sleeve 26 also has an outer circumferential face 34 that is of straight shape in the axial direction. The first bushing 20 is installed within the outer cylinder 14 by being press-fit into the outer cylinder 14 in the axial direction at the outer circumferential face 34 of the metal sleeve 26 thereof.

In FIG. 2, 36 denotes a second bushing consisting of a small bushing installed within the second outer cylinder 16. It has a metal rigid inner cylinder 38 and a rubber elastic body 40 attached to the outer circumferential face thereof. In this second bushing 36 as well, the rubber elastic body 40 is integrally bonded by vulcanization to the inner cylinder 38. The inner cylinder 38 has an outer circumferential face of straight shape in the axial direction, with wall thickness in the diametrical direction being uniform from one end to the other in the axial direction.

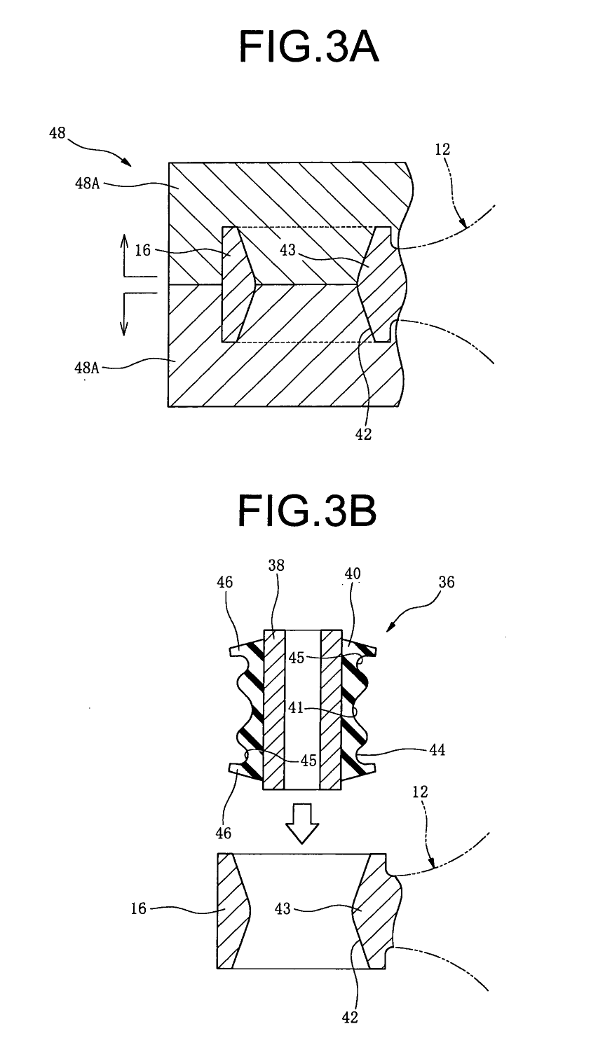

The second outer cylinder 16 has an inner circumferential face 42 of inwardly protruding shape that becomes smaller in diameter moving towards the center from the axial ends. 43 in the drawing represents a protruding portion. On the other hand, as shown in FIG. 3B, the rubber elastic body 40 of the second bushing 36, in its state prior to being press-fit, has on the outer circumferential face 44 and axial center portion thereof a diametrically inwardly annular central recessed portion 41 that corresponds to the inwardly protruding shape of the second outer cylinder 16, and further in proximity to the axial ends thereof a pair of diametrically inwardly annular side recessed portions 45 whose depth is made smaller than the central recessed portion 41. The central recessed portion 41 has a large radius of curvature in section than does the side recessed portions 45. These central and side recessed portions 41, 45 extend continuously circumferentially with the substantially same cross sectional shape. At the two axial ends are disposed flange portions 46 that project diametrically outward in annular configuration. In the state prior to being press-fit, the flange portions 46 are slant toward axially inwardly.

The torque rod 10 depicted in FIG. 1 and FIG. 2 is installed between the engine side and the vehicle body side with, for example, the second bushing 36 composed of the small bushing being fastened at the inner cylinder 38 to the engine side, and with the first bushing 20 composed of the large bushing being fastened at the inner cylinder 22 to the car body side, to thereby receive torque from the engine and limit displacement of the engine in the roll direction, as well as limit displacement of the engine in the front-back direction. Vibration isolation between the engine side and the body side is provided on the basis of elastic deformation of the rubber elastic bodies 24, 40.

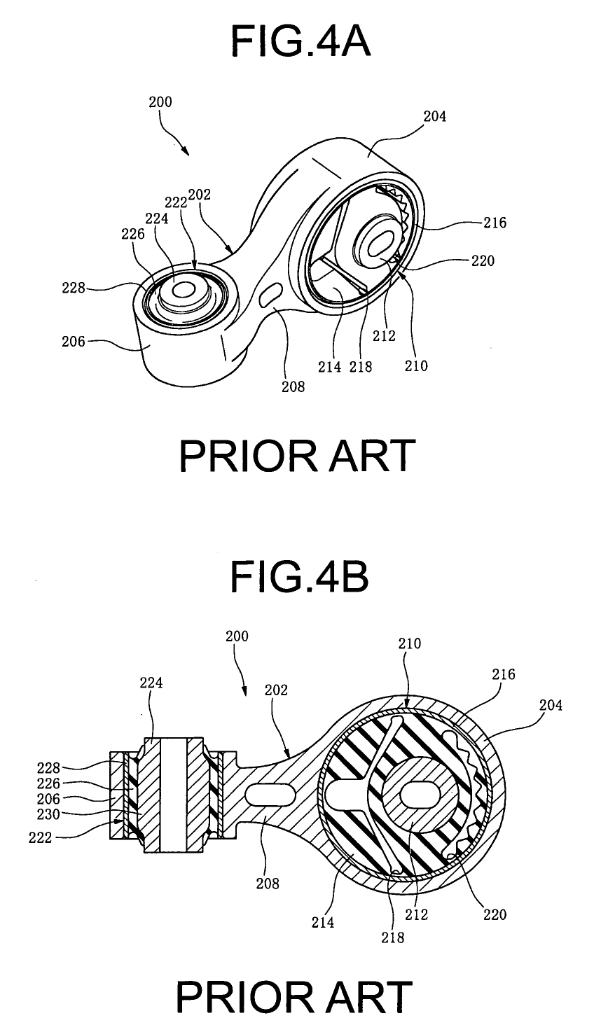

In the torque rod 10 of the embodiment, the first bushing 20 is secured installed within the first outer cylinder 14 with the outer circumferential face 34 of the metal sleeve 26 press-fit with the inside circumferential face 32 of the first outer cylinder 14 in the axial direction. On the other hand, the second bushing 36 consisting of the small bushing does not have a metal sleeve 26 like the first bushing 20, and is secured installed with the outer circumferential face 44 of the rubber elastic body 40 press-fit directly with the inside circumferential face 42 of the second outer cylinder 16 in the axial direction. After the second bushing 36 has been securely installed by press-fitting, it is prevented from becoming dislodged, by means of the central recessed portion 41 situated on the outer circumferential face 44 and axial center portion of the rubber elastic body 40, and the protruding portion 43 situated in the axial center portion on the inside circumferential face 42 of the second outer cylinder 16. In the embodiment, by means of providing the second outer cylinder 16 with the protruding portion 43, the diametrical thickness of the rubber elastic body 40 overall is made thinner, while the second bushing 36 maintains characteristics comparable to the prior art torque rod 200 depicted in FIG. 4.

The torque rod body 12 comprises a die-cast aluminum component (molded component), with the second outer cylinder 16 being formed by means of a forming mold 48 of split construction as shown in FIG. 3A. As shown in the drawing, once molded, the split mold 48A is parted in the upward direction in the drawing to release the component from the forming mold 48. Since the draft angle required for demolding is formed automatically in the portion of the split mold 48A that forms the inside circumferential face 42 of the second outer cylinder 16, mold release subsequent to molding can be carried out well.

In the embodiment described hereinabove, in addition to the fact that there is no longer any need for the second bushing 36 consisting of the small bushing to be provided with a metal sleeve as was required in the prior art, accordingly reducing metal sleeve cost per se, there is also no longer any need for a bonding process to bond the metal sleeve and the rubber elastic body 40 together during the fabrication process, a caulking process in order to constrict the diameter of the metal sleeve after vulcanization, or a cutting process performed on the inside circumferential face 42 of the outer cylinder 16 prior to press-fitting. Additionally, since there is no need to provide a protruding portion on the outside circumferential face of the inner cylinder 38, the cost of fabricating the second bushing 36 and of installing the second bushing 36 in the outer cylinder can be made lower. Thus, the cost of the torque rod 10 per se can be reduced.

Additionally, since the metal sleeve can be dispensed with and the need to provide a protruding portion to the inner cylinder 38 is obviated, the weight of the second bushing 36, and accordingly the weight of the torque rod 10, can be reduced so as to respond to the demand for lighter vehicle weight. On the other hand, since the rubber elastic body 40 of the second bushing 36 is thin, the characteristics required of the torque rod can be maintained.

Further, since the shape of the second outer cylinder 16 is an inwardly protruding shape in which the inner circumferential face 42 becomes smaller in diameter moving towards the center from the axial ends, it is possible to impart to the forming mold 48 the draft angle for forming the torque rod body 12. In addition, the shape of the inner cylinder is not limited to the illustrated embodiment. For instance, the inner cylinder may have an axially intermediate large-diameter portion.

The embodiment of the invention described in detail herein is merely exemplary. For example, it would be possible to implement the invention on a parallel type torque rod in which the first bushing and the second bushing are parallel. In the example hereinabove, the torque rod body is a die-cast aluminum component of aluminum alloy, but in certain instances it would be possible for it to be a molded resin component or a molded component of some other material, with advantages analogous to those described previously. It is also to be understood that the present invention may be embodied with various other changes, modifications and improvements, which may occur to those skilled in the art, without departing from the spirit and scope of the invention defined in the following claims.

1. A torque rod comprising:
a rigid torque rod body of a form in which first and second outer cylinders at both ends are linked to each other by a linking portion; and
a first and a second bushing each having a rigid inner cylinder and a rubber elastic body affixed thereabout, the first and second bushings being respectively installed within first and second outer cylinders, wherein
the second outer cylinder has an inside peripheral wall of inwardly protruding shape that becomes smaller in diameter moving towards the center from the axial ends; and the rubber elastic body of the second bushing is a solid member having a shape corresponding to the inwardly protruding shape, with the second bushing installed directly press-fit in the axial direction into the second outer cylinder, at an outer circumferential face of the rubber elastic body.

2. A torque rod according to claim 1, wherein the rubber elastic body of the second bushing has a diametrically inwardly annular recessed portion open in an outer circumferential face thereof at an axially intermediate portion, corresponding to the inwardly protruding shape of the second outer cylinder.

3. A torque rod according to claim 1, wherein the torque rod body is a molded component composed of molding material injected in a fluid state into a forming mold and hardened.

4. A torque rod according to claim 1, wherein the first bushing is a large bushing of larger diameter than the second bushing, and the second bushing is a small bushing.

5. A torque rod according to claim 1, wherein the rubber elastic body of the first bushing comprising the large bushing has hollow portions disposed at both sides of the inner cylinder in the axial direction of said linking portion, which coincides with a vehicle front-back direction.

6. A torque rod according to claim 1, wherein the rubber elastic body of the second bushing in a state prior to being press-fit has a diametrically inwardly annular central recessed portion open in an outer circumferential face thereof at an axially intermediate portion, and a pair of diametrically inwardly annular side recessed portions open in the outer circumferential face thereof at both axial sides of the central recessed portion, with a depth length smaller than that of the central recessed portion, while a pair of flange portions 46 integrally formed at two axial ends thereof so as to project diametrically outward in annular configuration.

7. A method of producing a torque rod including a rigid torque rod body of a form in which first and second outer cylinders at both ends are linked to each other by a linking portion; and a first and a second bushing each having a rigid inner cylinder and a rubber elastic body affixed thereabout, the first and second bushings being respectively installed within first and second outer cylinders, wherein the second outer cylinder has an inside peripheral wall of inwardly protruding shape that becomes smaller in diameter moving towards the center from the axial ends; and the rubber elastic body of the second bushing is a solid member having a shape corresponding to the inwardly protruding shape, with the second bushing installed directly press-fit in the axial direction into the second outer cylinder, at an outer circumferential face of the rubber elastic body, the method comprising the steps of:
preparing the second outer cylinder by die-casting so that the second outer cylinder has the inside peripheral wall of inwardly protruding shape,
preparing the second bushing by forming and bonding the rubber elastic body onto an outer circumferential face of the rigid inner cylinder by vulcanization such that the rubber elastic body in a state prior to being press-fit has a diametrically inwardly annular central recessed portion open in an outer circumferential face thereof at an axially intermediate portion, and a pair of diametrically inwardly annular side recessed portions open in the outer circumferential face thereof at both axial sides of the central recessed portion with a depth length smaller than that of the central recessed portion, while a pair of flange portions 46 integrally formed at two axial ends thereof so as to project diametrically outward in annular configuration; and (c) press fitting the prepared second bushing directly in the axial direction into the prepared second outer cylinder at the outer circumferential face thereof so that the rubber elastic body has a shape corresponding to the inwardly protruding shape by means of an elastic deformation thereof, and
press fitting the prepared second bushing directly in the axial direction into the prepared second outer cylinder at the outer circumferential face thereof so that the rubber elastic body has a shape corresponding to the inwardly protruding shape by means of an elastic deformation thereof.
